(19) United States
(12) Patent Application Publication
(10) Pub. No.: US 2020/0019939 A1
(43) Pub. Date: Jan. 16, 2020

(54) System, Method, and Computer Program Product for Providing Electronic Funds Transfers Based on Issuer System Requirements

(71) Applicant: Visa International Service Association, San Francisco, CA (US)

(72) Inventors: Steven Andrew Wolf, San Francisco, CA (US); Ajay Chalana, San Ramon, CA (US); Sivakumaran Durairaj, Belmont, CA (US); Anandan Ethirkottai Sundararajan, Singapore (SG)

(21) Appl. No.: 16/036,086

(22) Filed: Jul. 16, 2018

(51) Int. Cl. G06Q 20/10; G06Q 20/40

(52) U.S. Cl. CPC G06Q 20/10; G06Q 20/405; G06Q 20/4037

(57) ABSTRACT

Provided is a computer-implemented method for providing an electronic funds transfer (EFT) based on issuer system requirements that includes receiving an EFT request associated with an account, the EFT request associated with a transfer of an amount of funds to the account, determining whether an issuer system supports the transfer to the account according to a first electronic fund transfer protocol, determining second electronic fund transfer protocol settings data associated with performing the transfer to the account using the second electronic fund transfer protocol based on determining that the issuer system that issued the account of the user does not support the transfer to the account of the user according to the first electronic fund transfer protocol, and processing the transfer to the account in real-time based on the second electronic fund transfer protocol settings data. A system and computer program product are also disclosed.

### BACKGROUND OF THE INVENTION

### 1. Field of the Invention

This invention relates generally to systems, devices, products, apparatus, and methods that are used for providing electronic funds transfers, and in one particular embodiment, to a system, product, and method for providing electronic funds transfers based on issuer system requirements.

### 2. Technical Considerations

An electronic funds transfer (EFT) may include the electronic transfer of money from an account of a financial institution to another account of the financial institution or to another account of a different financial institution. An EFT may include cardholder-initiated transactions (e.g., transaction using a payment card such as a credit or debit card), a direct deposit payment initiated by a payer, direct debit payments for which a merchant debits a consumer's account for payment for goods or services, a wire transfer via an international banking network, such as SWIFT, electronic bill payment using online banking, which may be delivered by EFT or paper check, or a transaction involving stored value of electronic money, (e.g., a transaction involving a private currency). In some instances, the EFT may include a transfer of money within a single financial institution or across multiple institutions, via computer-based systems, without the direct intervention of employees of the financial institution. An EFT within the same financial institution, may be referred to as a peer-to-peer transfer.

However, a financial institution, such as an issuer institution, may not be able to support all types of EFTs. For example, an issuer institution may not be able to support a type of EFT referred to as an original credit transaction (OCT), also called a push payment, based on security risks associated with the OCT (e.g., security risks associated with providing secure data regarding an account). In such an example, the issuer institution may not be able to electronically transfer money to an account issued by the issuer institution where the money is to be received from an account of another financial institution based on an OCT via a transaction service provider. In this way, the other financial institution may not be aware that the issuer institution may not be able to electronically transfer money based on an OCT, and the other financial institution may be required to communicate follow-up messages to determine whether the money was electronically transferred to the account issued by the issuer institution from the account of the other financial institution. Additionally, the issuer institution may not be aware that the electronic transfer of the money based on the OCT is being attempted, and the issuer institution may fail to notify the other financial institution that the issuer institution does not support an OCT. In addition, the issuer institution may be required to expend time, network, and/or processing resources to electronically transfer the money to the account issued by the issuer institution from the account of the other financial institution independent of a real-time transfer, such as an OCT.

### SUMMARY OF THE INVENTION

Accordingly, systems, devices, products, apparatus, and/or methods for determining a category alignment of an account are disclosed that overcome some or all of the deficiencies of the prior art.

According to a non-limiting embodiment, provided is a method for providing an electronic funds transfer (EFT) based on issuer system requirements. The method comprises receiving, with at least one processor, an EFT request associated with an account of a user, the EFT request associated with a transfer of an amount of funds to the account of the user; determining, with at least one processor, whether an issuer system that issued the account of the user supports the transfer of the amount of funds to the account of the user according to a first electronic fund transfer protocol based on receiving the EFT request; determining, with at least one processor, second electronic fund transfer protocol settings data associated with performing the transfer of the amount of funds to the account of the user using the second electronic fund transfer protocol based on determining that the issuer system that issued the account of the user does not support the transfer of the amount of funds to the account of the user according to the first electronic fund transfer protocol; and processing, with at least one processor, the transfer of the amount of funds to the account of the user in real-time based on the second electronic fund transfer protocol settings data.

According to another non-limiting embodiment, provided is a system for providing an EFT based on issuer system requirements. The system comprises at least one processor programmed or configured to receive an EFT request associated with an account of a user, the EFT request associated with a transfer of an amount of funds to the account of the user; determine that an issuer system that issued the account of the user does not support the transfer of the amount of funds to the account of the user according to a first electronic fund transfer protocol based on receiving the EFT request; determine second electronic fund transfer protocol settings data associated with performing the transfer of the amount of funds to the account of the user using the second electronic fund transfer protocol based on determining that the issuer system that issued the account of the user does not support the transfer of the amount of funds to the account of the user according to the first electronic fund transfer protocol; and process the transfer of the amount of funds to the account of the user in real-time based on the second electronic fund transfer protocol settings data.

According to a further non-limiting embodiment, provided is a computer program product for providing an EFT based on issuer system requirements. The computer program product comprises at least one non-transitory computer-readable medium including one or more instructions that, when executed by at least one processor, cause the at least one processor to receive an EFT request associated with an account of a user, the EFT request associated with a transfer of an amount of funds to the account of the user; determine that an issuer system that issued the account of the user does not support the transfer of the amount of funds to the account of the user according to a first electronic fund transfer protocol based on receiving the EFT request; determine second electronic fund transfer protocol settings data associated with performing the transfer of the amount of funds to the account of the user using the second electronic fund transfer protocol based on determining that the issuer system that issued the account of the user does not support the transfer of the amount of funds to the account of the user according to the first electronic fund transfer protocol; and process the transfer of the amount of funds to the account of the user in real-time based on the second electronic fund transfer protocol settings data.

Further embodiments or aspects are set forth in the following numbered clauses:

Clause 1: A method for providing an electronic funds transfer (EFT) based on issuer system requirements, the method comprising: receiving, with at least one processor, an electronic funds transfer (EFT) request associated with an account of a user, the EFT request associated with a transfer of an amount of funds to the account of the user; determining, with at least one processor, whether an issuer system that issued the account of the user supports the transfer of the amount of funds to the account of the user according to a first electronic fund transfer protocol based on receiving the EFT request; determining, with at least one processor, second electronic fund transfer protocol settings data associated with performing the transfer of the amount of funds to the account of the user using the second electronic fund transfer protocol based on determining that the issuer system that issued the account of the user does not support the transfer of the amount of funds to the account of the user according to the first electronic fund transfer protocol; and processing, with at least one processor, the transfer of the amount of funds to the account of the user in real-time based on the second electronic fund transfer protocol settings data.

Clause 2: The method of clause 1, wherein the EFT request is associated with a statement credit amount regarding a balance associated with the account of the user.

Clause 3: The method of clauses 1 or 2, wherein processing the transfer of the amount of funds to the account of the user in real-time based on the second electronic fund transfer protocol comprises: communicating a statement credit advice request message to the issuer system, wherein the statement credit advice request message comprises information associated with an authorization of the transfer of the amount of funds to the account of the user.

Clause 4: The method of any of clauses 1-3, further comprising: receiving a statement advice response message from the issuer system, wherein the statement advice response message comprises information associated with a completion of the transfer of the amount of funds to the account of the user from an account associated with a financial institution.

Clause 5: The method of any of clauses 1-4, wherein processing the transfer of the amount of funds to the account of the user in real-time based on the second electronic fund transfer protocol comprises: processing the transfer of the amount of funds to the account of the user in real-time based on return transaction protocol.

Clause 6: The method of any of clauses 1-5, further comprising: determining that the issuer system that issued the account of the user supports the transfer of the amount of funds to the account of the user according to the first electronic fund transfer protocol based on receiving the EFT request; determining first electronic fund transfer protocol settings data associated with performing the transfer of the amount of funds to the account of the user using the first electronic fund transfer protocol based on determining that the issuer system that issued the account of the user supports the transfer of the amount of funds to the account of the user according to the first electronic fund transfer protocol; and processing the transfer of the amount of funds to the account of the user in real-time based on the first electronic fund transfer protocol settings data.

Clause 7: The method of any of clauses 1-6, further comprising: determining an EFT request type of the EFT request; and determining the second electronic fund transfer protocol settings data associated with performing the transfer of the amount of funds to the account of the user using the second electronic fund transfer protocol based on determining that the EFT request type corresponds to the second electronic fund transfer protocol.

Clause 8: A system for providing an electronic funds transfer (EFT) based on issuer system requirements, the system comprising: at least one processor, wherein the at least one processor is programmed or configured to: receive an electronic funds transfer (EFT) request associated with an account of a user, the EFT request associated with a transfer of an amount of funds to the account of the user; determine that an issuer system that issued the account of the user does not support the transfer of the amount of funds to the account of the user according to a first electronic fund transfer protocol based on receiving the EFT request; determine second electronic fund transfer protocol settings data associated with performing the transfer of the amount of funds to the account of the user using the second electronic fund transfer protocol based on determining that the issuer system that issued the account of the user does not support the transfer of the amount of funds to the account of the user according to the first electronic fund transfer protocol; and process the transfer of the amount of funds to the account of the user in real-time based on the second electronic fund transfer protocol settings data.

Clause 9: The system of clause 8, wherein the EFT request is associated with a statement credit amount regarding a balance associated with the account of the user.

Clause 10: The system of clauses 8 or 9, wherein, when processing the transfer of the amount of funds to the account of the user in real-time based on the second electronic fund transfer protocol, the at least one processor is programmed or configured to: communicate a statement credit advice request message to the issuer system, wherein the statement credit advice request message comprises information associated with an authorization of the transfer of the amount of funds to the account of the user.

Clause 11: The system of any of clauses 8-10, wherein the at least one processor is further programmed or configured to: receive a statement advice response message from the issuer system, wherein the statement advice response message comprises information associated with a completion of the transfer of the amount of funds to the account of the user from an account associated with a financial institution.

Clause 12: The system of any of clauses 8-11, wherein, when processing the transfer of the amount of funds to the account of the user in real-time based on the second electronic fund transfer protocol, the at least one processor is programmed or configured to: process the transfer of the amount of funds to the account of the user in real-time based on a return transaction protocol.

Clause 13: The system of any of clauses 8-12, wherein the at least one processor is further programmed or configured to: determine that the issuer system that issued the account of the user supports the transfer of the amount of funds to the account of the user according to the first electronic fund transfer protocol based on receiving the EFT request; determine first electronic fund transfer protocol settings data associated with performing the transfer of the amount of funds to the account of the user using the first electronic fund transfer protocol based on determining that the issuer system that issued the account of the user supports the transfer of the amount of funds to the account of the user according to the first electronic fund transfer protocol; and process the transfer of the amount of funds to the account of the user in real-time based on the first electronic fund transfer protocol settings data.

Clause 14: The system of any of clauses 8-13, wherein the at least one processor is further programmed or configured to: determine an EFT request type of the EFT request; and determine the second electronic fund transfer protocol settings data associated with performing the transfer of the amount of funds to the account of the user using the second electronic fund transfer protocol based on determining that the EFT request type corresponds to the second electronic fund transfer protocol.

Clause 15: A computer program product for providing an electronic funds transfer (EFT) based on issuer system requirements, the computer program product comprising at least one non-transitory computer-readable medium including one or more instructions that, when executed by at least one processor, cause the at least one processor to: receive an electronic funds transfer (EFT) request associated with an account of a user, the EFT request associated with a transfer of an amount of funds to the account of the user; determine that an issuer system that issued the account of the user does not support the transfer of the amount of funds to the account of the user according to a first electronic fund transfer protocol based on receiving the EFT request; determine second electronic fund transfer protocol settings data associated with performing the transfer of the amount of funds to the account of the user using the second electronic fund transfer protocol based on determining that the issuer system that issued the account of the user does not support the transfer of the amount of funds to the account of the user according to the first electronic fund transfer protocol; and process the transfer of the amount of funds to the account of the user in real-time based on the second electronic fund transfer protocol settings data.

Clause 16: The computer program product of clause 15, wherein the EFT request is associated with a statement credit amount regarding a balance associated with the account of the user.

Clause 17: The computer program product of clauses 15 or 16, wherein, the one or more instructions that cause the at least one processor to process the transfer of the amount of funds to the account of the user in real-time based on the second electronic fund transfer protocol cause the at least one processor to: communicate a statement credit advice request message to the issuer system, wherein the statement credit advice request message comprises information associated with an authorization of the transfer of the amount of funds to the account of the user.

Clause 18: The computer program product of any of clauses 15-17, wherein the one or more instructions further cause the at least one processor to: receive a statement advice response message from the issuer system, wherein the statement advice response message comprises information associated with a completion of the transfer of the amount of funds to the account of the user from an account associated with a financial institution.

Clause 19: The computer program product of any of clauses 15-18, wherein, the one or more instructions that cause the at least one processor to process the transfer of the amount of funds to the account of the user in real-time based on the second electronic fund transfer protocol cause the at least one processor to: process the transfer of the amount of funds to the account of the user in real-time based on the return transaction protocol.

Clause 20: The computer program product of any of clauses 15-19, wherein the one or more instructions further cause the at least one processor to: determine that the issuer system that issued the account of the user supports the transfer of the amount of funds to the account of the user according to the first electronic fund transfer protocol based on receiving the EFT request; determine first electronic fund transfer protocol settings data associated with performing the transfer of the amount of funds to the account of the user using the first electronic fund transfer protocol based on determining that the issuer system that issued the account of the user supports the transfer of the amount of funds to the account of the user according to the first electronic fund transfer protocol; and process the transfer of the amount of funds to the account of the user in real-time based on the first electronic fund transfer protocol settings data.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a,” “an,” and “the” include plural referents unless the context clearly dictates otherwise.

### BRIEF DESCRIPTION OF THE DRAWINGS

Additional advantages and details of the invention are explained in greater detail below with reference to the exemplary embodiments that are illustrated in the accompanying schematic figures, in which:

FIG. 1 is a diagram of a non-limiting embodiment of an environment in which systems, devices, products, apparatus, and/or methods, described herein, may be implemented according to the principles of the present invention;

FIG. 2 is a diagram of a non-limiting embodiment of components of one or more devices of FIG. 1;

FIG. 3 is a flowchart of a non-limiting embodiment of a process for providing an electronic funds transfer (EFT) based on issuer system requirements; and

FIGS. 4A-4C are diagrams of an implementation of a non-limiting embodiment of the process shown in FIG. 3.

### DESCRIPTION OF THE INVENTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments or aspects of the invention. Hence, specific dimensions and other physical characteristics related to the embodiments or aspects of the embodiments disclosed herein are not to be considered as limiting unless otherwise indicated.

No aspect, component, element, structure, act, step, function, instruction, and/or the like used herein should be construed as critical or essential unless explicitly described as such. Also, as used herein, the articles “a” and “an” are intended to include one or more items, and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

Some non-limiting embodiments are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, and/or the like.

As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and communicates the processed information to the second unit. In some non-limiting embodiments, a message may refer to a network packet (e.g., a data packet and/or the like) that includes data. It will be appreciated that numerous other arrangements are possible.

As used herein, the terms “issuer institution,” “portable financial device issuer,” “issuer,” or “issuer bank” may refer to one or more entities that provide one or more accounts to a user (e.g., customer, consumer, and/or the like) for conducting transactions (e.g., payment transactions), such as initiating credit card payment transactions and/or debit card payment transactions. For example, an issuer institution may provide an account identifier, such as a personal account number (PAN), to a user that uniquely identifies one or more accounts associated with that user. The account identifier may be embodied on a portable financial device, such as a physical financial instrument (e.g., a payment card) and/or may be electronic and used for electronic payments. In some non-limiting embodiments, an issuer institution may be associated with a bank identification number (BIN) that uniquely identifies the issuer institution. As used herein “issuer institution system” may refer to one or more computer systems operated by or on behalf of an issuer institution, such as a server computer executing one or more software applications. For example, an issuer institution system may include one or more authorization servers for authorizing a payment transaction.

As used herein, the term “account identifier” may refer to one or more types of identifiers associated with a user account (e.g., an account identifier, a PAN, a card number, a payment card number, a token, and/or the like). In some non-limiting embodiments, an issuer institution may provide an account identifier (e.g., a PAN, a token, and/or the like) to a user that uniquely identifies one or more accounts associated with that user. The account identifier may be embodied on a physical financial instrument (e.g., a portable financial instrument, a payment card, a credit card, a debit card, and/or the like) and/or may be electronic information communicated to the user that the user may use for electronic payment transactions. In some non-limiting embodiments, the account identifier may be an original account identifier, where the original account identifier was provided to a user at the creation of the account associated with the account identifier. In some non-limiting embodiments, the account identifier may be an account identifier (e.g., a supplemental account identifier) that is provided to a user after the original account identifier was provided to the user. For example, if the original account identifier is forgotten, stolen, and/or the like, a supplemental account identifier may be provided to the user. In some non-limiting embodiments, an account identifier may be directly or indirectly associated with an issuer institution such that an account identifier may be a token that maps to a PAN or other type of identifier. Account identifiers may be alphanumeric, any combination of characters and/or symbols, and/or the like.

As used herein, the term “merchant” may refer to one or more entities (e.g., operators of retail businesses) that provide goods and/or services, and/or access to goods and/or services, to a user based on a transaction, such as a payment transaction. As used herein “merchant system” may refer to one or more computer systems operated by or on behalf of a merchant, such as a server executing one or more software applications. As used herein, the term “product” may refer to one or more goods and/or services offered by a merchant.

As used herein, a “point-of-sale (POS) device” may refer to one or more devices, which may be used by a merchant to conduct a transaction (e.g., a payment transaction) and/or process a transaction. For example, a POS device may include one or more computers, peripheral devices, card readers, near-field communication (NFC) receivers, radio frequency identification (RFID) receivers, and/or other contactless transceivers or receivers, contact-based receivers, payment terminals, computers, servers, input devices, and/or the like.

As used herein, a “POS system” may refer to one or more computers and/or peripheral devices used by a merchant to conduct a transaction. For example, a POS system may include one or more POS devices and/or other like devices that may be used to conduct a payment transaction. A POS system (e.g., a merchant POS system) may also include one or more server computers programmed or configured to process online payment transactions through webpages, mobile applications, and/or the like.

As used herein, the term “acquirer” may refer to an entity licensed by the transaction service provider and approved by the transaction service provider to originate transactions (e.g., payment transactions) using a portable financial device associated with the transaction service provider. As used herein, the term “acquirer system” may also refer to one or more computer systems, computer devices, and/or the like operated by or on behalf of an acquirer. The transactions the acquirer may originate may include payment transactions (e.g., purchases, and/or the like). In some non-limiting embodiments, the acquirer may be authorized by the transaction service provider to assign merchant or service providers to originate transactions using a portable financial device of the transaction service provider. The acquirer may contract with payment facilitators to enable the payment facilitators to sponsor merchants. The acquirer may monitor compliance of the payment facilitators in accordance with regulations of the transaction service provider. The acquirer may conduct due diligence of the payment facilitators and ensure proper due diligence occurs before signing a sponsored merchant. The acquirer may be liable for all transaction service provider programs that the acquirer operates or sponsors. The acquirer may be responsible for the acts of the acquirer's payment facilitators, merchants that are sponsored by an acquirer's payment facilitator, and/or the like. In some non-limiting embodiments, an acquirer may be a financial institution, such as a bank.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network, such as Visa®, MasterCard®, American Express®, or any other entity that processes transactions. As used herein, “transaction service provider system” may refer to one or more computer systems operated by or on behalf of a transaction service provider, such as a transaction service provider system executing one or more software applications. A transaction service provider system may include one or more processors and, in some non-limiting embodiments, may be operated by or on behalf of a transaction service provider.

As used herein, the term “portable financial device” may refer to a payment card (e.g., a credit or debit card), a gift card, a smartcard, smart media, a payroll card, a healthcare card, a wristband, a machine-readable medium containing account information, a keychain device or fob, an RFID transponder, a retailer discount or loyalty card, as examples. The portable financial device may include volatile or non-volatile memory to store information (e.g., an account identifier, a name of the account holder, and/or the like).

As used herein, the terms “client” and “client device” may refer to one or more client-side devices or systems, remote from a transaction service provider, used to initiate or facilitate a transaction. As an example, a “client device” may refer to one or more POS devices and/or POS systems used by a merchant. It will be appreciated that a client device may be any electronic device configured to communicate with one or more networks and initiate or facilitate transactions such as, but not limited to, one or more computers, portable computers, tablet computers, cellular phones, wearable devices (e.g., watches, glasses, lenses, clothing, and/or the like), personal digital assistant (PDAs), and/or other like devices. Moreover, a “client” may also refer to an entity, such as a merchant, that owns, utilizes, and/or operates a client device for initiating transactions with a transaction service provider.

As used herein, the term “server” may refer to one or more computing devices, such as processors, storage devices, and/or similar computer components that communicate with client devices and/or other computing devices over a network, such as the Internet or private networks, and, in some examples, facilitate communication among other servers and/or client devices. It will be appreciated that various other arrangements are possible. As used herein, the term “system” may refer to one or more computing devices or combinations of computing devices such as, but not limited to, processors, servers, client devices, software applications, and/or other like components. In addition, reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

Non-limiting embodiments of the present invention are directed to systems, methods, and computer program products for providing an electronic funds transfer (EFT) based on issuer system requirements. In some non-limiting embodiments, a method may include receiving an EFT request associated with an account of a user, the EFT request associated with a transfer of an amount of funds to the account of the user, determining whether an issuer system that issued the account of the user supports the transfer of the amount of funds to the account of the user according to a first electronic fund transfer protocol based on receiving the EFT request, determining second electronic fund transfer protocol settings data associated with performing the transfer of the amount of funds to the account of the user using the second electronic fund transfer protocol based on determining that the issuer system that issued the account of the user does not support the transfer of the amount of funds to the account of the user according to the first electronic fund transfer protocol, and processing the transfer of the amount of funds to the account of the user in real-time based on the second electronic fund transfer protocol settings data.

In this way, embodiments of the present invention allow for EFTs to occur even if an issuer system may not be able to support all types of EFTs. For example, an issuer institution that may not be able to support an original credit transaction (OCT) based on security risks associated with the OCT, may be able to electronically transfer money to an account issued by the issuer institution where the money is to be received from an account of another financial institution based on the OCT via a transaction service provider. In this way, network resources may be based on the issuer institution not having to determine whether the money was electronically transferred to the account issued by the issuer institution from the account of the other financial institution. Additionally, embodiments of the present invention allow for the issuer institution to be aware that the electronic transfer of the money based on the OCT is being attempted and the issuer institution may fail to notify the other financial institution that the issuer institution does not support the OCT. In addition, the expenditure of time, network, and/or processing resources may be reduced to electronically transfer the money to the account issued by the issuer institution from the account of the other financial institution independent of the OCT, while the transfer may still take place in real-time.

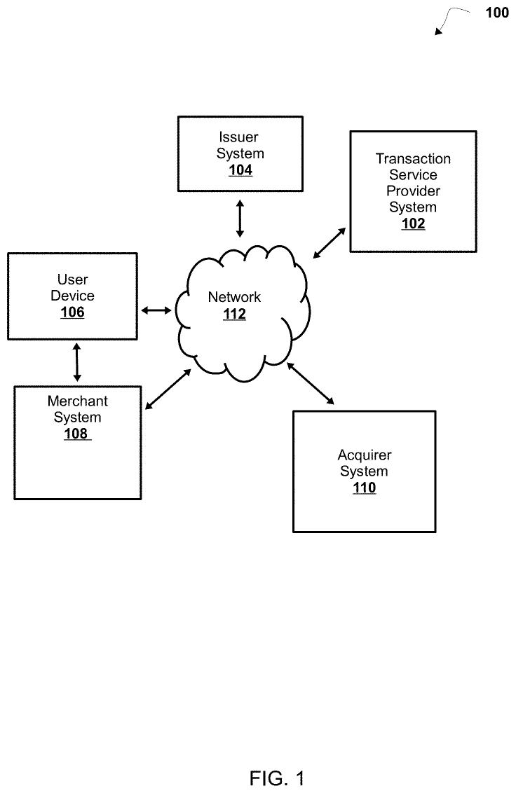

Referring now to FIG. 1, FIG. 1 is a diagram of an example environment 100 in which devices, systems, and/or methods, described herein, may be implemented. As shown in FIG. 1, environment 100 includes transaction service provider system 102, issuer system 104, user device 106, merchant system 108, acquirer system 110, and network 112. Transaction service provider system 102, issuer system 104, user device 106, merchant system 108, and/or acquirer system 110 may interconnect (e.g., establish a connection to communicate) via wired connections, wireless connections, or a combination of wired and wireless connections.

Transaction service provider system 102 may include one or more devices capable of receiving information from issuer system 104, user device 106, merchant system 108, and/or acquirer system 110 via network 112 and/or communicating information to issuer system 104, user device 106, merchant system 108, and/or acquirer system 110 via network 112. For example, transaction service provider system 102 may include a computing device, such as a server (e.g., a transaction processing server), a group of servers, and/or other like devices. In some non-limiting embodiments, transaction service provider system 102 may be associated with a transaction service provider as described herein. In some non-limiting embodiments, transaction service provider system 102 may be in communication with a data storage device, which may be local or remote to the transaction service provider system 102. In some non-limiting embodiments, transaction service provider system 102 may be capable of receiving information from, storing information in, communicating information to, or searching information stored in a data storage device.

Issuer system 104 may include one or more devices capable of receiving information from transaction service provider system 102, user device 106, merchant system 108, and/or acquirer system 110 via network 112 and/or communicating information to transaction service provider system 102, user device 106, merchant system 108, and/or acquirer system 110 via network 112. For example, issuer system 104 may include a computing device, such as a server, a group of servers, and/or other like devices. In some non-limiting embodiments, issuer system 104 may be associated with an issuer institution as described herein. For example, issuer system 104 may be associated with an issuer institution that issued a credit account, debit account, credit card, debit card, and/or the like to a user associated with user device 106.

User device 106 may include one or more devices capable of receiving information from transaction service provider system 102, issuer system 104, merchant system 108, and/or acquirer system 110 via network 112 and/or communicating information to transaction service provider system 102, issuer system 104, merchant system 108, and/or acquirer system 110 via network 112. For example, user device 106 may include a client device and/or the like. In some non-limiting embodiments, user device 106 may or may not be capable of receiving information (e.g., from merchant system 108) via a short range wireless communication connection (e.g., an NFC communication connection, an RFID communication connection, a Bluetooth® communication connection, and/or the like) and/or communicating information (e.g., to merchant system 108) via a short range wireless communication connection.

Merchant system 108 may include one or more devices capable of receiving information from transaction service provider system 102, issuer system 104, user device 106, and/or acquirer system 110 via network 112 and/or communicating information to transaction service provider system 102, issuer system 104, user device 106, and/or acquirer system 110 via network 112. Merchant system 108 may also include a device capable of receiving information from user device 106 via network 112, a communication connection (e.g., an NFC communication connection, an RFID communication connection, a Bluetooth® communication connection, and/or the like) with user device 106, and/or the like, and/or communicating information to user device 106 via the network, the communication connection, and/or the like. For example, merchant system 108 may include a computing device, such as a server, a group of servers, a client device, a group of client devices, and/or other like devices. In some non-limiting embodiments, merchant system 108 may be associated with a merchant as described herein. In some non-limiting embodiments, merchant system 108 may include one or more user devices 106. For example, merchant system 108 may include user device 106 that allows a merchant to communicate information to transaction service provider system 102. In some non-limiting embodiments, merchant system 108 may include one or more devices, such as computers, computer systems, and/or peripheral devices capable of being used by a merchant to conduct a payment transaction with a user. For example, merchant system 108 may include a POS device and/or a POS system.

Acquirer system 110 may include one or more devices capable of receiving information from transaction service provider system 102, issuer system 104, user device 106, and/or merchant system 108 via network 112 and/or communicating information to transaction service provider system 102, issuer system 104, user device 106, and/or merchant system 108 via network 112. For example, acquirer system 110 may include a computing device, a server, a group of servers, and/or the like. In some non-limiting embodiments, acquirer system 110 may be associated with an acquirer as described herein.

Network 112 may include one or more wired and/or wireless networks. For example, network 112 may include a cellular network (e.g., a long-term evolution (LTE) network, a third generation (3G) network, a fourth generation (4G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of these or other types of networks.

The number and arrangement of devices and networks shown in FIG. 1 are provided as an example. There may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of environment 100 may perform one or more functions described as being performed by another set of devices of environment 100.

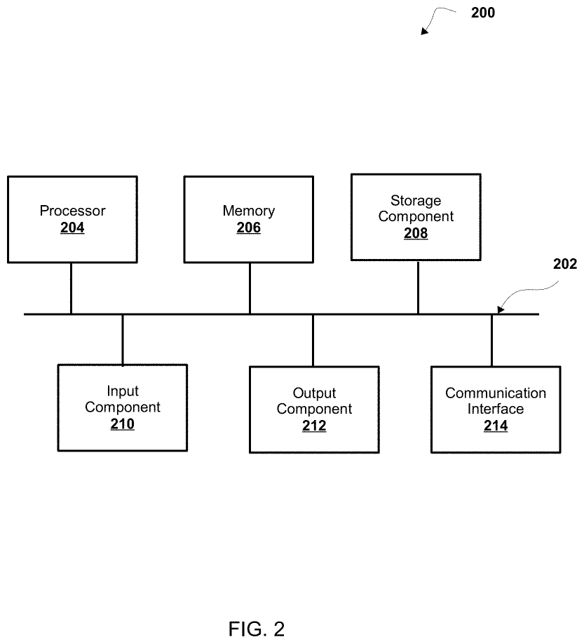

Referring now to FIG. 2, FIG. 2 is a diagram of example components of a device 200. Device 200 may correspond to transaction service provider system 102, and/or one or more devices of issuer system 104, user device 106, and/or merchant system 108. In some non-limiting embodiments, transaction service provider system 102, issuer system 104, user device 106, and/or merchant system 108 may include at least one device 200 and/or at least one component of device 200. As shown in FIG. 2, device 200 may include a bus 202, a processor 204, memory 206, a storage component 208, an input component 210, an output component 212, and a communication interface 214.

Bus 202 may include a component that permits communication among the components of device 200. In some non-limiting embodiments, processor 204 may be implemented in hardware, firmware, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read only memory (ROM), and/or another type of dynamic or static storage device (e.g., flash memory, magnetic memory, optical memory, etc.) that stores information and/or instructions for use by processor 204.

Storage component 208 may store information and/or software related to the operation and use of device 200. For example, storage component 208 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 210 may include a component that permits device 200 to receive information, such as via user input (e.g., a touch screen display, a keyboard, a keypad, a mouse, a button, a switch, a microphone, etc.). Additionally or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.).

Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium (e.g., a non-transitory computer-readable medium) is defined herein as a non-transitory memory device. A memory device includes memory space located inside of a single physical storage device or memory space spread across multiple physical storage devices.

Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally or alternatively, hardwired circuitry may be used in place of or in combination with software instructions to perform one or more processes described herein. Thus, embodiments described herein are not limited to any specific combination of hardware circuitry and software.

The number and arrangement of components shown in FIG. 2 are provided as an example. In some non-limiting embodiments, device 200 may include additional components, fewer components, different components, or differently arranged components than those shown in FIG. 2. Additionally or alternatively, a set of components (e.g., one or more components) of device 200 may perform one or more functions described as being performed by another set of components of device 200.

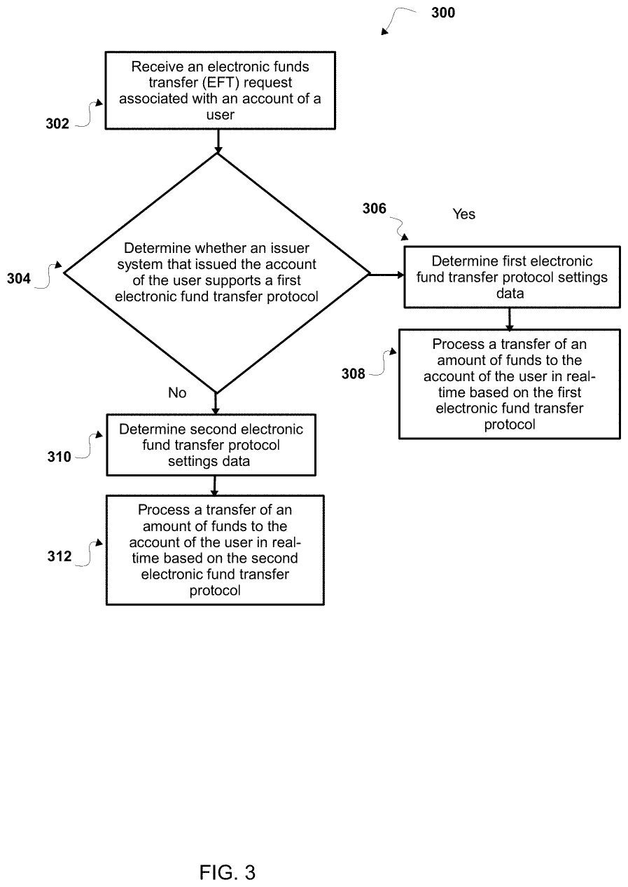

Referring now to FIG. 3, FIG. 3 is a flowchart of a non-limiting embodiment of a process 300 for determining a merchant category alignment of an account. In some non-limiting embodiments, one or more of the steps of process 300 may be performed (e.g., completely, partially, etc.) by transaction service provider system 102 (e.g., one or more devices of transaction service provider system 102). In some non-limiting embodiments, one or more of the steps of process 300 may be performed (e.g., completely, partially, etc.) by another device or a group of devices separate from or including transaction service provider system 102, such as issuer system 104 (e.g., one or more devices of issuer system 104), user device 106, or merchant system 108 (e.g., one or more devices of merchant system 108).

As shown in FIG. 3, at step 302, process 300 includes receiving an electronic funds transfer (EFT) request associated with an account of a user. For example, transaction service provider system 102 may receive an EFT request associated with an account of a user. The EFT request associated with a transfer of an amount of funds to the account of the user. In some non-limiting embodiments, the EFT request is associated with a statement credit amount regarding an outstanding balance associated with the account of the user. For example, the EFT request may be associated with a statement credit amount that is to be applied to an outstanding balance associated with the account of the user by an issuer system (e.g., issuer system 104) that issued the account of the user.

In some non-limiting embodiments, the EFT request may include data associated with an account identifier associated with the account of the user (e.g., data associated with a PAN associated with the account of the user), data associated with an amount of money to be transferred to the account of the user based on the EFT (e.g., data associated with a dollar amount to be transferred to the account of the user based on the EFT), and/or data associated with a description of a basis for the EFT (e.g., data associated with a description of a reward associated with a rewards program that is the basis for the EFT, data associated with a description of a rebate associated with a rebate program that is the basis for the EFT, data associated with a description of a credit based on a return transaction of a good or a service provided by a merchant that is the basis for the EFT, and/or the like).

In some non-limiting embodiments, transaction service provider system 102 may generate the EFT request associated with the account of the user based on a payment transaction that is conducted between a user associated with user device 106 and a merchant associated with merchant system 108. For example, transaction service provider system 102 may generate the EFT request based on the payment transaction that is conducted between the user associated with user device 106 and the merchant associated with merchant system 108, where the payment transaction involves a benefit (e.g., an offer, a coupon, a rebate, and/or the like) associated with the account of the user. The benefit may be provided by a transaction service provider associated with transaction service provider system 102, an issuer institution associated with issuer system 104, and/or a merchant associated with merchant system 108.

In some non-limiting embodiments, transaction service provider system 102 may receive the EFT request associated with the account of the user from issuer system 104, merchant system 108, and/or acquirer system 110. For example, issuer system 104, merchant system 108, and/or acquirer system 110 may communicate the EFT request after a payment transaction associated with the EFT request (e.g., a payment transaction associated with the EFT request, where the EFT request is associated with an account of the user involved in the payment transaction) is conducted between a user associated with user device 106 and a merchant associated with merchant system 108. In some non-limiting embodiments, transaction service provider system 102 may validate the EFT request based on receiving the EFT request. For example, transaction service provider system 102 may validate the EFT request by determining an EFT request parameter (e.g., a transaction amount of the payment transaction associated with the EFT request, identification data associated with an identification of the user involved in the payment transaction associated with the EFT request, and/or the like) with the EFT request. Transaction service provider system 102 may compare the EFT request parameter to a predetermined threshold value of the EFT request. If transaction service provider system 102 determines that the EFT request parameter satisfies the predetermined threshold value of the EFT request, then transaction service provider system 102 may validate the EFT request. If transaction service provider system 102 determines that the EFT request parameter does not satisfy the predetermined threshold value of the EFT request, then transaction service provider system 102 may not validate the EFT request.

In some non-limiting embodiments, transaction service provider system 102 may communicate an error message (e.g., a validation error message) to issuer system 104, user device 106, merchant system 108, and/or acquirer system 110 if transaction service provider system 102 does not validate the EFT request. In some non-limiting embodiments, transaction service provider system 102 may store the EFT request in a database if transaction service provider system 102 validates the EFT request. In some non-limiting embodiments, transaction service provider system 102 may process the EFT request based on validating the EFT request. For example, transaction service provider system 102 may process the EFT request by communicating a success message (e.g., a validation success message) to issuer system 104, user device 106, merchant system 108, and/or acquirer system 110 when transaction service provider system 102 processes the EFT request.

In some non-limiting embodiments, transaction service provider system 102 may retrieve the EFT request associated with the account of the user from a database associated with transaction service provider system 102. For example, transaction service provider system 102 may retrieve the EFT request from the database associated with transaction service provider system 102 during processing of the EFT request. In some non-limiting embodiments, transaction service provider system 102 may retrieve a status of the EFT request associated with the account of the user from a database associated with transaction service provider system 102. For example, transaction service provider system 102 may retrieve the status of the EFT request from the database associated with transaction service provider system 102 based on receiving a status request message regarding the EFT request from issuer system 104, user device 106, merchant system 108, and/or acquirer system 110.

In some non-limiting embodiments, transaction service provider system 102 may communicate a status response message based on retrieving the status of the EFT request associated with the account of the user from the database. For example, transaction service provider system 102 may communicate the status response message that includes data associated with a status of the EFT request (e.g., data regarding the payment transaction associated with the EFT request, an indication that the EFT request is pending, an indication that the EFT request is valid, an indication that a transfer associated with the EFT request is complete, and/or the like) based on retrieving the status of the EFT request from the database. In some non-limiting embodiments, transaction service provider system 102 may communicate the status response message to issuer system 104, user device 106, merchant system 108, and/or acquirer system 110. For example, transaction service provider system 102 may communicate the status response message to issuer system 104, user device 106, merchant system 108, and/or acquirer system 110 based on generating the status response message.

As further shown in FIG. 3, at step 304, process 300 includes determining whether an issuer system that issued the account of the user supports a first electronic fund transfer protocol. For example, transaction service provider system 102 may determine whether issuer system 104 (e.g., issuer system 104 that issued the account of the user) supports the transfer of the amount of funds to the account of the user according to a first electronic funds transfer protocol based on receiving the EFT request.

In some non-limiting embodiments, transaction service provider system 102 may determine whether the issuer system that issued the account of the user supports the transfer of the amount of funds to the account of the user according to a first electronic funds transfer protocol based on an account number (e.g., a PAN) of the account of the user. For example, transaction service provider system 102 may receive account number data associated with the account number of the account of the user included in the EFT request. Transaction service provider system 102 may compare the account number data included in the EFT request to account number data stored in a database to determine identification data associated with an identification of an issuer system (e.g., an issuer system associated with an issuer institution) that issued the account of the user. Transaction service provider system 102 may determine whether the issuer system that issued the account of the user supports the first electronic fund transfer protocol based on the identification data associated with an identification of an issuer system that issued the account of the user.

In some non-limiting embodiments, transaction service provider system 102 may use the identification data associated with the identification of the issuer system that issued the account of the user to determine if issuer system data associated with the issuer system includes an indication that the issuer system supports the first electronic fund transfer protocol. If transaction service provider system 102 determines that issuer system data associated with the issuer system includes an indication that the issuer system supports the first electronic fund transfer protocol, transaction service provider system 102 may determine that the issuer system supports the first electronic fund transfer protocol. If transaction service provider system 102 determines that issuer system data associated with the issuer system does not include an indication that the issuer system supports the first electronic fund transfer protocol, transaction service provider system 102 may determine that the issuer system supports the first electronic fund transfer protocol.

In some non-limiting embodiments, transaction service provider system 102 may determine whether the issuer system that issued the account of the user supports the transfer of the amount of funds to the account of the user according to an original credit transaction (OCT) protocol. For example, transaction service provider system 102 may determine whether the issuer system that issued the account of the user supports the transfer of the amount of funds to the account of the user according to an OCT protocol based on receiving the EFT request.

In some non-limiting embodiments, transaction service provider system 102 may determine an EFT request type of the EFT request. For example, transaction service provider system 102 may determine the EFT request type of the EFT request based on receiving the EFT request and/or retrieving the EFT request. In some non-limiting embodiments, the EFT request type may be an OCT request type, a statement credit advice request type, or a return transaction request type.

In some non-limiting embodiments, transaction service provider system 102 may determine whether the EFT request specifies a type of transfer. If the EFT request specifies a type of transfer (e.g., a type of transfer associated with an OCT request type, a type of transfer associated with a statement credit advice request type, a type of transfer associated with a return transaction request type, and/or the like), transaction service provider system 102 may determine the type of transfer specified by the EFT request and process the EFT request based on the type of transfer specified by the EFT request. If the EFT request does specify a type of transfer, transaction service provider system 102 may determine a default type of transfer for the EFT request and process the EFT request based on the default type of transfer for the EFT request. In some non-limiting embodiments, the default type of transfer for the EFT request may be a type of transfer associated with an OCT request type.

As further shown in FIG. 3, at step 306, process 300 includes determining first electronic fund transfer protocol settings data. For example, transaction service provider system 102 may determine first electronic fund transfer protocol settings data (e.g., OCT protocol settings data) associated with performing the transfer of the amount of funds to the account of the user based on determining that the issuer system that issued the account of the user supports the transfer of the amount of funds to the account of the user according to the first electronic fund transfer protocol. In some non-limiting embodiments, transaction service provider system 102 may retrieve the first electronic funds transfer protocol settings data from a database associated with transaction service provider system 102. For example, transaction service provider system 102 may retrieve the first electronic funds transfer protocol settings data from the database based on determining that issuer system 104 that issued the account of the user supports a first electronic fund transfer protocol.

In some non-limiting embodiments, transaction service provider system 102 may receive the first electronic funds transfer protocol settings data from issuer system 104, merchant system 108, and/or acquirer system 110. For example, transaction service provider system 102 may receive the first electronic funds transfer protocol settings data from issuer system 104, merchant system 108, and/or acquirer system 110 based on transaction service provider system 102 performing an application programming interface (API) call to issuer system 104, merchant system 108, and/or acquirer system 110.

In some non-limiting embodiments, transaction service provider system 102 may determine OCT protocol settings data. For example, transaction service provider system 102 may determine OCT protocol settings data based on determining that an EFT request type of the EFT request corresponds to an OCT request type.

In some non-limiting embodiments, transaction service provider system 102 may communicate data associated with an updated status of an EFT request associated with the account of the user. For example, transaction service provider system 102 may communicate the data associated with the updated status of the EFT request associated with the account of the user based on determining first electronic fund transfer protocol settings data.

As further shown in FIG. 3, at step 308, process 300 includes processing a transfer of an amount of funds to the account of the user in real-time based on the first electronic fund transfer protocol. For example, transaction service provider system 102 may process the transfer of the amount of funds to the account of the user in real-time based on the first electronic funds transfer protocol. In some non-limiting embodiments, transaction service provider system 102 may process the transfer of the amount of funds to the account of the user in real-time based on an OCT protocol. For example, transaction service provider system 102 may process the transfer of the amount of funds to the account of the user from an account associated with issuer system 104, an account associated with merchant system 108, and/or an account associated with acquirer system 110 in real-time based on an OCT according to the OCT transfer protocol.

In some non-limiting embodiments, transaction service provider system 102 may attempt to process a transfer of an amount of funds to the account of the user in real-time based on the first electronic fund transfer protocol, where the first electronic fund transfer protocol is associated with a default type of transfer for an EFT request. For example, transaction service provider system 102 may attempt to process the transfer of an amount of funds to the account of the user in real-time based on an electronic fund transfer protocol that is associated with the default type of transfer for the EFT request and the default type of transfer may be a type of transfer associated with an OCT request type. In some non-limiting embodiments, transaction service provider system 102 may determine that an issuer system (e.g., issuer system 104) does not support the default type of transfer for the EFT request and transaction service provider system 102 may determine to process a transfer of an amount of funds to the account of the user in real-time based on a second electronic fund transfer protocol. For example, transaction service provider system 102 may determine that the issuer system does not support the default type of transfer for the EFT request and transaction service provider system 102 may determine to process a transfer of an amount of funds to the account of the user in real-time based on a second electronic fund transfer protocol that is associated with a type of transfer associated with a statement credit advice request type.

As further shown in FIG. 3, at step 310, process 300 includes determining second electronic fund transfer protocol settings data. For example, transaction service provider system 102 may determine second electronic funds transfer protocol settings data (e.g., statement credit advice protocol settings data or return transaction protocol settings data) associated with performing the transfer of the amount of funds to the account of the user based on determining that the issuer system that issued the account of the user does not support the transfer of the amount of funds to the account of the user according to the first electronic funds transfer protocol. In some non-limiting embodiments, transaction service provider system 102 may retrieve the second electronic funds transfer protocol settings data from a database associated with transaction service provider system 102. For example, transaction service provider system 102 may retrieve the second electronic funds transfer protocol settings data from the database based on determining that issuer system 104 that issued the account of the user supports a first electronic fund transfer protocol.

In some non-limiting embodiments, transaction service provider system 102 may receive the second electronic funds transfer protocol settings data from issuer system 104, merchant system 108, and/or acquirer system 110. For example, transaction service provider system 102 may receive the second electronic funds transfer protocol settings data from issuer system 104, merchant system 108, and/or acquirer system 110 based on transaction service provider system 102 performing an API call to issuer system 104, merchant system 108, and/or acquirer system 110.

In some non-limiting embodiments, transaction service provider system 102 may determine statement credit advice protocol settings data. For example, transaction service provider system 102 may determine statement credit advice protocol settings data based on determining that an EFT request type of the EFT request corresponds to a statement credit advice request type.

In some non-limiting embodiments, transaction service provider system 102 may communicate data associated with an updated status of an EFT request associated with the account of the user. For example, transaction service provider system 102 may communicate the data associated with the updated status of the EFT request associated with the account of the user based on determining second electronic fund transfer protocol settings data.

As further shown in FIG. 3, at step 312, process 300 includes processing a transfer of an amount of funds to the account of the user in real-time based on the second electronic fund transfer protocol. For example, transaction service provider system 102 may process the transfer of the amount of funds (e.g., the amount of funds associated with the EFT request) to the account of the user in real-time based on the second electronic funds transfer protocol.

In some non-limiting embodiments, transaction service provider system 102 may process the transfer of the amount of funds to the account of the user in real-time based on statement credit advice protocol. For example, transaction service provider system 102 may communicate a statement credit advice request message to issuer system 104. In some non-limiting embodiments, the statement credit advice request message may include an indication that issuer system 104 may perform an action to cause the transfer of the amount of funds to the account of the user in real-time. In some non-limiting embodiments, transaction service provider system 102 may receive a statement credit advice response message from issuer system 104 based on issuer system 104 performing an action to cause the transfer of the amount of funds to the account of the user in real-time.

In some non-limiting embodiments, issuer system 104 may complete a transfer of an amount of funds to the account of the user from an account associated with a financial institution. For example, issuer system 104 may complete the transfer of the amount of funds to the account of the user from an account associated with a financial institution of merchant system 108 (e.g., acquirer system 110) based on receiving the statement credit advice request message from transaction service provider system 102.

In some non-limiting embodiments, transaction service provider system 102 may communicate a statement credit advice request message to issuer system 104. For example, transaction service provider system 102 may communicate the statement credit advice request message that includes information associated with an authorization of a transfer of an amount of funds to the account of the user. In some non-limiting embodiments, transaction service provider system 102 may receive a statement credit advice response message from the issuer system, where the statement credit advice response message comprises information associated with a completion of the transfer of the amount of funds to the account of the user from an account associated with a financial institution.

In some non-limiting embodiments, transaction service provider system 102 may receive a statement credit advice response message from issuer system 104. For example, transaction service provider system 102 may receive the statement credit advice response message from issuer system 104 based on issuer system 104 completing the transfer of the amount of funds to the account of the user from an account associated with a financial institution.

In some non-limiting embodiments, transaction service provider system 102 may process the transfer of the amount of funds to the account of the user in real-time based on return transaction protocol. For example, transaction service provider system 102 may process the transfer of the amount of funds to the account of the user in real-time based on where the amount of funds is equal to a transaction amount of a payment transaction associated with the EFT request.

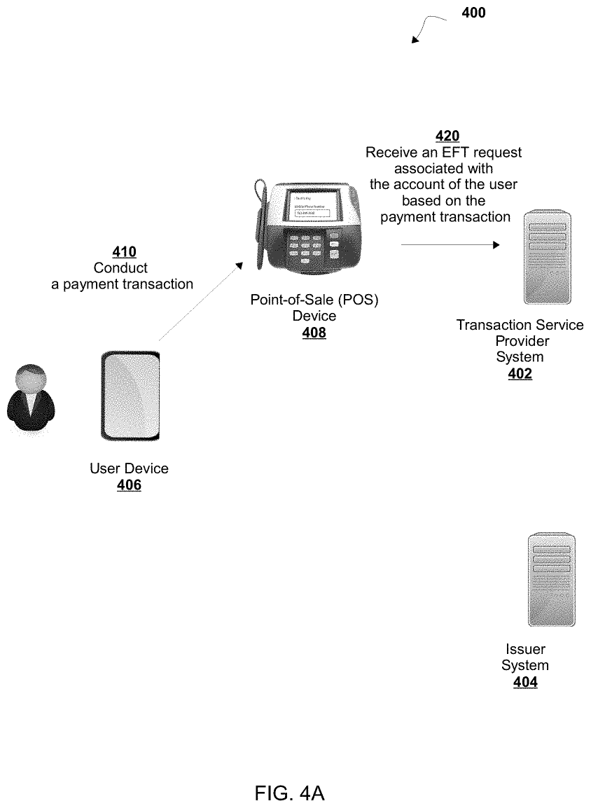

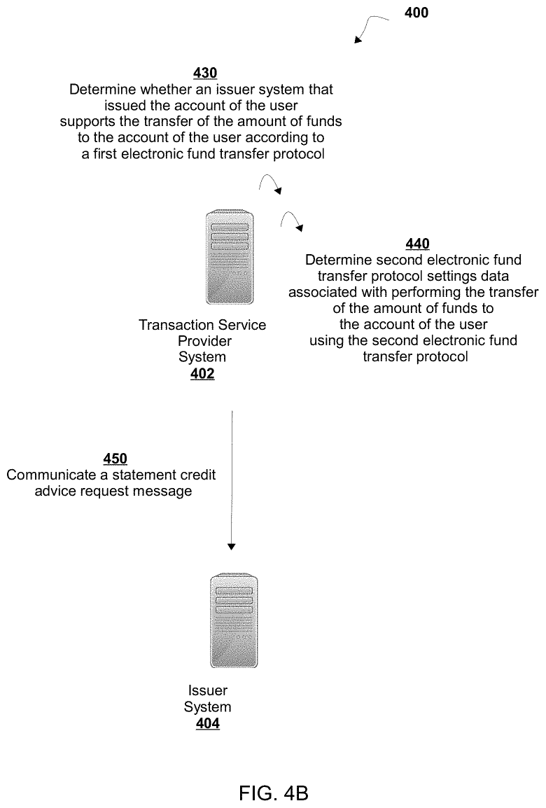

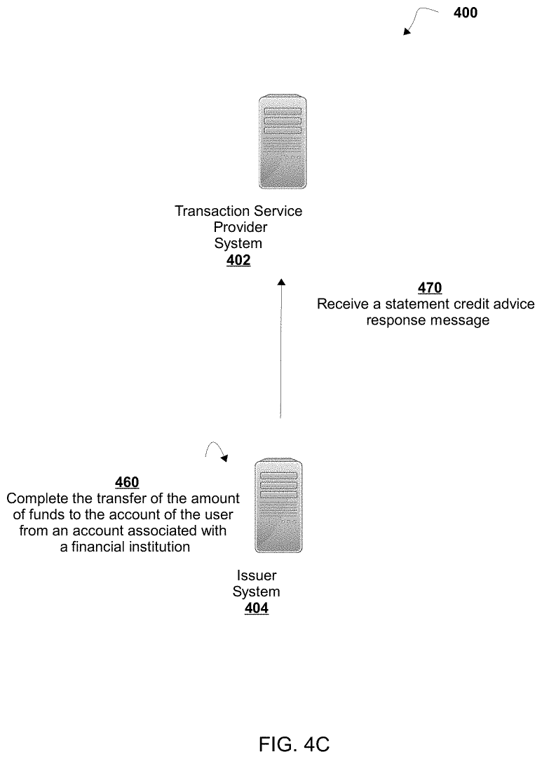

FIGS. 4A-4C are diagrams of an overview of a non-limiting embodiment of implementation 400 relating to process 300 shown in FIG. 3. As shown in FIGS. 4A-4C, implementation 400 may include transaction service provider system 402, issuer system 404, user device 406, and POS device 408. In some non-limiting embodiments, POS device 408 may be associated with (e.g., components of) merchant system 108 and may be the same or similar to merchant system 108. In some non-limiting embodiments, transaction service provider system 402 may be the same or similar to transaction service provider system 102, user device 406 may the same or similar to user device 106, and issuer system 404 may be the same as or similar to issuer system 104 as described above.

As shown by reference number 410 in FIG. 4A, a user associated with user device 406 may conduct a payment transaction with a merchant associated with POS device 408. For example, the user associated with user device 406 may conduct the payment transaction with the merchant associated with POS device 408, where the payment transaction involves a benefit (e.g., an offer, a coupon, a rebate, and/or the like) associated with the account of the user.

As further shown by reference number 420 in FIG. 4A, transaction service provider system 402 may receive an EFT request associated with the account of the user based on the payment transaction. For example, transaction service provider system 402 may receive the EFT request associated with the account of the user from a merchant system associated with POS device 408 after the payment transaction is conducted. In some non-limiting embodiments, transaction service provider system 402, issuer system 404, and/or a merchant system associated with POS device 408 may generate the EFT request based on the payment transaction. For example, transaction service provider system 402, issuer system 404, and/or a merchant system associated with POS device 408 may generate the EFT request based on a benefit involved in the payment transaction.

As shown by reference number 430 in FIG. 4B, transaction service provider system 402 may determine whether an issuer system that issued the account of the user supports the transfer of the amount of funds to the account of the user according to a first electronic fund transfer protocol. For example, transaction service provider system 402 may determine whether an issuer system that issued the account of the user supports the transfer of the amount of funds to the account of the user according to an OCT transfer protocol. In some non-limiting embodiments, transaction service provider system 402 may determine that the issuer system that issued the account of the user does not support the transfer of the amount of funds to the account of the user according to the first electronic fund transfer protocol and that the issuer system supports the transfer of the amount of funds to the account of the user according to the second electronic fund transfer protocol.

As further shown by reference number 440 in FIG. 4B, transaction service provider system 402 may determine second electronic fund transfer protocol settings data associated with performing the transfer of the amount of funds to the account of the user using the second electronic fund transfer protocol associated with the second electronic fund transfer protocol settings data. For example, transaction service provider system 402 may determine second electronic fund transfer protocol settings data associated with performing the transfer of the amount of funds to the account of the user using a statement credit advice transfer protocol associated with the second electronic fund transfer protocol settings data.

As further shown by reference number 450 in FIG. 4B, transaction service provider system 402 may communicate a statement credit advice request message to issuer system 404. For example, transaction service provider system 402 may communicate a statement credit advice request message to issuer system 404 based on the second electronic fund transfer protocol settings data associated with the statement credit advice transfer protocol.

As shown by reference number 460 in FIG. 4C, issuer system 404 may complete the transfer of the amount of funds to the account of the user from an account associated with a financial institution. For example, issuer system 404 may complete the transfer of the amount of funds to the account of the user from an account associated with a financial institution of a merchant associated with POS device 408 (e.g., acquirer system 110) based on receiving the statement credit advice request message from transaction service provider system 402. As further shown by reference number 470 in FIG. 4C, transaction service provider system 402 may receive a statement credit advice response message from issuer system 404. For example, transaction service provider system 402 may receive the statement credit advice response message from issuer system 404 based on issuer system 404 completing the transfer of the amount of funds to the account of the user from the account associated with the financial institution.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

The invention claimed is:

1. A method for providing an electronic funds transfer (EFT) based on issuer system requirements comprising:
receiving, with at least one processor, an EFT request associated with an account of a user, the EFT request associated with a transfer of an amount of funds to the account of the user;
determining, with at least one processor, whether an issuer system that issued the account of the user supports the transfer of the amount of funds to the account of the user according to a first electronic fund transfer protocol based on receiving the EFT request;
determining, with at least one processor, second electronic fund transfer protocol settings data associated with performing the transfer of the amount of funds to the account of the user using a second electronic fund transfer protocol associated with the second electronic fund transfer protocol settings data based on determining that the issuer system that issued the account of the user does not support the transfer of the amount of funds to the account of the user according to the first electronic fund transfer protocol; and
processing, with at least one processor, the transfer of the amount of funds to the account of the user in real-time based on the second electronic fund transfer protocol settings data.

2. The method of claim 1, wherein the EFT request is associated with a statement credit amount regarding a balance associated with the account of the user.

3. The method of claim 1, wherein processing the transfer of the amount of funds to the account of the user in real-time based on the second electronic fund transfer protocol comprises:
communicating a statement credit advice request message to the issuer system, wherein the statement credit advice request message comprises information associated with an authorization of the transfer of the amount of funds to the account of the user.

4. The method of claim 3, further comprising:
receiving a statement advice response message from the issuer system, wherein the statement advice response message comprises information associated with a completion of the transfer of the amount of funds to the account of the user from an account associated with a financial institution.

5. The method of claim 1, wherein processing the transfer of the amount of funds to the account of the user in real-time based on the second electronic fund transfer protocol comprises:
processing the transfer of the amount of funds to the account of the user in real-time based on a return transaction protocol.

6. The method of claim 1, further comprising:
determining that the issuer system that issued the account of the user supports the transfer of the amount of funds to the account of the user according to the first electronic fund transfer protocol based on receiving the EFT request;
determining first electronic fund transfer protocol settings data associated with performing the transfer of the amount of funds to the account of the user using the first electronic fund transfer protocol based on determining that the issuer system that issued the account of the user supports the transfer of the amount of funds to the account of the user according to the first electronic fund transfer protocol; and
processing the transfer of the amount of funds to the account of the user in real-time based on the first electronic fund transfer protocol settings data.

7. The method of claim 1, further comprising:
determining a EFT request type of the EFT request; and
determining the second electronic fund transfer protocol settings data associated with performing the transfer of the amount of funds to the account of the user using the second electronic fund transfer protocol based on determining that the EFT request type corresponds to the second electronic fund transfer protocol.

8. A system for providing an electronic funds transfer (EFT) based on issuer system requirements, the system comprising:
at least one processor, wherein the at least one processor is programmed or configured to:
receive an EFT request associated with an account of a user, the EFT request associated with a transfer of an amount of funds to the account of the user;
determine that an issuer system that issued the account of the user does not support the transfer of the amount of funds to the account of the user according to a first electronic fund transfer protocol based on receiving the EFT request;
determine second electronic fund transfer protocol settings data associated with performing the transfer of the amount of funds to the account of the user using a second electronic fund transfer protocol associated with the second electronic fund transfer protocol settings data based on determining that the issuer system that issued the account of the user does not support the transfer of the amount of funds to the account of the user according to the first electronic fund transfer protocol; and
process the transfer of the amount of funds to the account of the user in real-time based on the second electronic fund transfer protocol settings data.

9. The system of claim 8, wherein the EFT request is associated with a statement credit amount regarding a balance associated with the account of the user.

10. The system of claim 8, wherein, when processing the transfer of the amount of funds to the account of the user in real-time based on the second electronic fund transfer protocol, the at least one processor is programmed or configured to:
communicate a statement credit advice request message to the issuer system, wherein the statement credit advice request message comprises information associated with an authorization of the transfer of the amount of funds to the account of the user.

11. The system of claim 10, wherein the at least one processor is further programmed or configured to:
receive a statement advice response message from the issuer system, wherein the statement advice response message comprises information associated with a completion of the transfer of the amount of funds to the account of the user from an account associated with a financial institution.

12. The system of claim 8, wherein, when processing the transfer of the amount of funds to the account of the user in real-time based on the second electronic fund transfer protocol, the at least one processor is programmed or configured to:
process the transfer of the amount of funds to the account of the user in real-time based on a return transaction protocol.

13. The system of claim 8, wherein the at least one processor is further programmed or configured to:
determine that the issuer system that issued the account of the user supports the transfer of the amount of funds to the account of the user according to the first electronic fund transfer protocol based on receiving the EFT request;
determine the first electronic fund transfer protocol settings data associated with performing the transfer of the amount of funds to the account of the user using the first electronic fund transfer protocol based on determining that the issuer system that issued the account of the user supports the transfer of the amount of funds to the account of the user according to the first electronic fund transfer protocol; and
process the transfer of the amount of funds to the account of the user in real-time based on the first electronic fund transfer protocol settings data.

14. The system of claim 8, wherein the at least one processor is further programmed or configured to:
determine an EFT request type of the EFT request; and
determine the second electronic fund transfer protocol settings data associated with performing the transfer of the amount of funds to the account of the user using the second electronic fund transfer protocol based on determining that the EFT request type corresponds to the second electronic fund transfer protocol.

15. A computer program product for providing an electronic funds transfer (EFT) based on issuer system requirements, the computer program product comprising at least one non-transitory computer-readable medium including one or more instructions that, when executed by at least one processor, cause the at least one processor to:
receive an EFT request associated with an account of a user, the EFT request associated with a transfer of an amount of funds to the account of the user;
determine that an issuer system that issued the account of the user does not support the transfer of the amount of funds to the account of the user according to a first electronic fund transfer protocol based on receiving the EFT request;
determine second electronic fund transfer protocol settings data associated with performing the transfer of the amount of funds to the account of the user using a second electronic fund transfer protocol associated with the second electronic fund transfer protocol settings data based on determining that the issuer system that issued the account of the user does not support the transfer of the amount of funds to the account of the user according to the first electronic fund transfer protocol; and
process the transfer of the amount of funds to the account of the user in real-time based on the second electronic fund transfer protocol settings data.

16. The computer program product of claim 15, wherein the EFT request is associated with a statement credit amount regarding a balance associated with the account of the user.

17. The computer program product of claim 15, wherein, the one or more instructions that cause the at least one processor to process the transfer of the amount of funds to the account of the user in real-time based on the second electronic fund transfer protocol cause the at least one processor to:
communicate a statement credit advice request message to the issuer system, wherein the statement credit advice request message comprises information associated with an authorization of the transfer of the amount of funds to the account of the user.

18. The computer program product of claim 15, wherein the one or more instructions further cause the at least one processor to:
receive a statement advice response message from the issuer system, wherein the statement advice response message comprises information associated with a completion of the transfer of the amount of funds to the account of the user from an account associated with a financial institution.

19. The computer program product of claim 15, wherein, the one or more instructions that cause the at least one processor to process the transfer of the amount of funds to the account of the user in real-time based on the second electronic fund transfer protocol cause the at least one processor to:
process the transfer of the amount of funds to the account of the user in real-time based on the return transaction protocol.

20. The computer program product of claim 15, wherein the one or more instructions further cause the at least one processor to:
determine that the issuer system that issued the account of the user supports the transfer of the amount of funds to the account of the user according to the first electronic fund transfer protocol based on receiving the EFT request;
determine first electronic fund transfer protocol settings data associated with performing the transfer of the amount of funds to the account of the user using the first electronic fund transfer protocol based on determining that the issuer system that issued the account of the user supports the transfer of the amount of funds to the account of the user according to the first electronic fund transfer protocol; and
process the transfer of the amount of funds to the account of the user in real-time based on the first electronic fund transfer protocol settings data.
